(19) United States
(12) Patent Application Publication
(10) Pub. No.: US 2016/0371430 A1
(43) Pub. Date: Dec. 22, 2016

(54) METHOD AND DEVICE FOR ANALYSING A BIOLOGICAL SAMPLE

(71) Applicant: BIOMERIEUX SA, Marcy L'Etoile (FR)

(72) Inventors: Pierre Mahe, Lans En Vercors (FR); Jean-Baptiste Veyrieras, Lyon (FR)

(73) Assignee: BIOMERIEUX SA, Marcy L'Etoile (FR)

(21) Appl. No.: 14/901,974

(22) PCT Filed: Jul. 28, 2014
(86) PCT No.: PCT/FR2014/051952

§ 371 Date: Dec. 29, 2015

(30) Foreign Application Priority Data
Jul. 31, 2013 (FR) 1357614

(51) Int. Cl. G06F 19/24; G06F 17/11; G06F 17/16

(52) U.S. Cl. CPC G06F 19/24; G06F 17/16; G06F 17/11

(57) ABSTRACT

A method of detecting in a biological sample at least two microorganisms belonging to two different taxa, represented by intensity vectors Pⱼ obtained by multidimensional measurement technique,
including (i) acquiring a digital signal of the biological sample with the measurement
technology, (ii) determining an intensity vector x according to the acquired digital
signal, (iii) constructing a set {ŷₗ} of candidate models ŷₗ=(ŷⱼ,ŷ₀)ₗ modeling intensity vector x according to

$${\hat{x}}_{l} = {\sum }_{j = 1}^{K} {\hat{γ}}_{j} {P}_{j}^{( a )} + {\hat{γ}}_{0} {I}_{p}$$

relation

$${\hat{x}}_{l} = {\sum }_{j = 1}^{K} {\hat{γ}}_{j} {P}_{j}^{( a )} + {\hat{γ}}_{0} {I}_{p}$$

in which ∀jε[[1,K]], Pⱼ^{(a)}=Σᵢ₌₁^{K}aᵢⱼPᵢ; and ∀(i,j)ε[[1,K]]², aᵢⱼ is a predetermined
coefficient, (iv) selecting a candidate model \hat{γ}ₛₑₗ from set {\hat{γ}ₗ} according to

$${\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) )$$

relation

$${\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) )$$

in which Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and C_{c}(\hat{γ}ₗ) is a criterion quantifying the complexity of a candidate
model \hat{γ}ₗ, and (v) determining the presence in the biological sample of at least two taxa when at least two components of vector \hat{γ}ⱼ of \hat{γ}ₛₑₗ are greater than a positive threshold.

### FIELD OF THE INVENTION

The invention relates to the analysis of biological samples capable of comprising a plurality of different microorganisms, and more particularly to the detection and the identification of microbial mixtures, based on measurement techniques generating a multidimensional digital signal representative of the biological sample being analyzed.

### STATE OF THE ART

It is known to use spectrometry or spectroscopy to identify microorganisms, and more particularly bacteria. For this purpose, a sample of an unknown microorganism is prepared, after which a mass, vibrational, or fluorescence spectrum of the sample is acquired and pre-processed, particularly to eliminate the baseline and to eliminate the noise. The pre-processed spectrum is then “compared” by means of classification tools with a reference base constructed from a set of spectrums associated with taxa of identified microorganisms, for example, species, by a reference method.

More particularly, the identification of microorganisms by classification conventionally comprises a first step of determining, by means of a supervised learning, a classification model according to so-called “training” spectrums of microorganisms having their species previously known, the classification model defining a set of rules distinguishing these different species among the training spectrums, and a second step of identification, or of “prediction” of a specific unknown microorganism. This second step especially comprises acquiring a spectrum of the microorganism to be identified, pre-processing the spectrum, and applying to the pre-processed spectrum a prediction model constructed from the classification model to determine at least one species to which the unknown microorganism belongs.

Typically, a spectrometry or spectroscopy identification device thus comprises a spectrometer or spectroscope and an acquisition and processing unit receiving the measured spectrums, digitizing them to obtain a multidimensional digital intensity vector, and implementing the second above-mentioned step according to the generated digital vector. The first step is implemented by the manufacturer of the device who determines the classification model and the prediction model and integrates it in the machine before its use by a customer.

Up to now, whatever the considered measurement technique or identification algorithm, the analysis of a biological sample is limited to samples comprising a single type of microorganism. Indeed, the analysis of biological samples comprising a plurality of different microorganisms is particularly difficult and it can in particular be observed that prediction algorithms based on classification models fail in detecting that a biological sample comprises a plurality of microorganisms, and thus also in identifying the microorganisms contained in such a sample.

Thus, prior to any step of spectrometry or spectroscopy identification, a sample to be tested, containing microorganisms which are desired to be known, is first submitted to a step of biological treatment aiming at isolating the different types of microorganisms. A biological sample to be identified by spectrometry or spectroscopy is then prepared from a single type of isolated microorganism. For example, for the identification of bacteria, a solution of the product to be tested is prepared, after which the obtained solution is put together with one or a plurality of culture mediums, for example, on one or a plurality of Petri dishes. After incubation, different bacterial colonies are then identified and isolated, each of which can be subject to a subsequent identification.

Now, such a biological sample preparation may take a long time, certain types of microorganisms indeed requiring incubation times of a plurality of days. Further, certain microorganisms require a very specific culture medium to grow.

Apart from the cost that this generates, there always is a risk of not growing all the different microorganisms, included in the product to be tested, and thus a risk of “missing” a microorganism. This preliminary preparation step, made compulsory by the incapacity of identification algorithms based on classification models to efficiently analyze polymicrobial mixtures, is thus a significant source of error.

### DISCUSSION OF THE INVENTION

The present invention aims at providing a method of analyzing biological samples which enables to analyze a biological sample independently from the fact that it comprises one or a plurality of different microorganisms, according to a single measurement of the sample, particularly by spectroscopy, spectrometry, or any type of measurement generating a multidimensional digital intensity vector.

To achieve this, the invention aims at a method of detecting in a biological sample at least two microorganisms belonging to two different taxa from a predetermined set {yⱼ} of a number of K different reference taxa yⱼ, each reference taxon yⱼ being represented by a predetermined reference intensity vector Pⱼ of a space R^{p}, or “prototype”, obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample by the measurement technology;
determining an intensity vector x of R^{p} according to the acquired multidimensional digital signal;
constructing a set {\hat{γ}ₗ} lip a of candidate models \hat{γ}ₗ=(ŷ,ŷ₀)ₗ modeling intensity vector x according to relation:

$${\hat{x}}_{l} = {\sum }_{j = 1}^{K} {\hat{γ}}_{j} {P}_{j}^{( a )} + {\hat{γ}}_{0} {I}_{p}$$

in which expression:
   \hat{x}ₗ is a vector of R^{p} reconstructing intensity vector x with model \hat{γ}ₗ;
   ŷ₀ is a real scalar and Iₚ is the unit vector of R^{p};
   ∀jε[[1,K]], ŷⱼ is the j^{th} component of a vector ŷ of Rₗ^{p};
   ∀jε[[1,K]], pⱼ^{(a)}=Σᵢ₌₁^{K}aᵢⱼPᵢ; and
   ∀(i,j)ε[[1,K]]², aᵢⱼ is a predetermined coefficient;
selecting a candidate model ŷₛₑₗ from set {\hat{γ}ₗ} of candidate models \hat{γ}ₗ, solution of a problem according to relation:

$${\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) )$$

in which expression:
   Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and
   C_{c}(\hat{γ}ₗ), is a criterion quantifying the complexity of a candidate model \hat{γ}ₗ;
and determining the presence in the biological sample of at least two microorganisms belonging to different taxa of predetermined set {yⱼ} of taxa when at least two components ŷⱼ of vector ŷ of the selected candidate model ŷₛₑₗ are greater than a predetermined strictly positive threshold value.

To achieve this, the invention also aims at a method of identifying microorganisms present in a biological sample from a predetermined set {yⱼ} of a number of K different reference taxa yⱼ, each reference taxon yᵢ being represented by a predetermined intensity vector Pⱼ of a space R^{p} obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample with the measurement technology;
determining an intensity vector x of R^{p} according to the acquired multidimensional digital signal;
constructing a set {\hat{γ}ₗ} of candidate models \hat{γ}ₗ=(ŷ,ŷ₀)ₗ modeling intensity vector x according to relation:

$${\hat{x}}_{l} = {\sum }_{j = 1}^{K} {\hat{γ}}_{j} {P}_{j}^{( a )} + {\hat{γ}}_{0} {I}_{p}$$

in which expression:
   \hat{x}ₗ is a vector of R^{p} reconstructing intensity vector x with model \hat{γ}ₗ;
   ŷ₀ is a real scalar and Iₚ is the unit vector of R^{p};
   ∀jε[[1,K]], ŷⱼ is the j^{th} component of a vector ŷ of Rₗ^{K};
   ∀jε[[1,K]], Pⱼ^{(a)}=Σᵢ₌₁^{K}aᵢⱼPᵢ; and
   ∀(i,j)ε[[1,K]]², aᵢⱼ is a predetermined coefficient;
selecting a candidate model ŷₛₑₗ from set {\hat{γ}ₗ} of candidate models \hat{γ}ₗ, solution of a problem according to relation:

$${\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) )$$

in which expression:
   Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and
   C_{c}(\hat{γ}ₗ), is a criterion quantifying the complexity of a candidate model \hat{γ}ₗ;
and determining the presence in the biological sample of a microorganism of taxon yⱼ of the predetermined set {yⱼ} for each component ŷⱼ of vector ŷ of the selected candidate model ŷₛₑₗ greater than a strictly positive predetermined threshold value.

To achieve this, the invention also aims at a method of determining the relative abundance in a biological sample belonging to two different taxa from a predetermined set {yⱼ} of a number of K different reference taxa yⱼ, each reference taxon yⱼ being represented by a predetermined intensity vector Pⱼ of a space R^{p} obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample with the measurement technology;
determining an intensity vector x of R^{p} according to the acquired multidimensional digital signal;

constructing a set {\hat{γ}ₗ} of candidate models \hat{γ}ₗ=(ŷ,ŷ₀)ₗ modeling intensity vector x according to relation:

$${\hat{x}}_{l} = {\sum }_{j = 1}^{K} {\hat{γ}}_{j} {P}_{j}^{( a )} + {\hat{γ}}_{0} {I}_{p}$$

in which expression:
   \hat{x}ₗ is a vector of R^{p} reconstructing intensity vector x with model \hat{γ}ₗ;
   ŷ₀ is a real scalar and Iₚ is the unit vector of R^{p};
   ∀jε[[1,K]], ŷⱼ is the j^{th} component of a vector ŷ of Rₗ^{K};
   ∀jε[[1,K]], Pⱼ^{(a)}=Σᵢ₌₁^{K}aᵢⱼPᵢ; and
   ∀(i,j)ε[[1,K]]², aᵢⱼ is a predetermined coefficient;
selecting a candidate model ŷₛₑₗ from set {\hat{γ}ₗ} of candidate models \hat{γ}ₗ, solution of a problem according to relation:

$${\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) )$$

in which expression:
   Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and
   C_{c}(\hat{γ}ₗ), is a criterion quantifying the complexity of a candidate model \hat{γ}ₗ;
and determining the relative abundance in biological sample Cⱼ of a reference taxon yⱼ according to relation:

C=J(ŷₛₑₗ)
in which expression J is a matrix function of in Rₗ^{p}×Rₗ^{K} in Rₗ^{K} and C=(C₁ . . . Cⱼ, . . . C_{K})^{T} is a vector of Rₗ^{K} with ∀jε[[1,K]], Cⱼ is the relative abundance of reference taxon yⱼ.

“Detection” here means the determination of the polymicrobial character of a biological sample. The “identification” of a microorganism corresponds to the determination of data specific to the microorganism, for example, its species, its sub-species, its genus, its Gram, etc. . . . and more generally any data deemed useful used in the construction of a unique identity of the microorganism.

Term “taxon” particularly designates a wider notion than term “taxon” used to characterize the position of a node, of a leaf, or of a root of the taxonomic classification of living things. In the terms of the invention, term taxon designates any type of classification of living things deemed useful. Particularly, the invention applies to conventional taxonomic classifications, to classifications based on clinical phenotypes, and to hybrid classifications based on taxonomic characteristics in the conventional sense and on clinical phenotypes.

“Measurement technique” here means a measurement which comprises generating a complex signal which is digitized. Among this type of measurement, one may for example mention mass spectrometry, particularly MALDI-TOF spectrometry and ESI-MS spectrometry, vibrational spectroscopy, particularly RAMAN spectroscopy, fluorescence spectroscopy, particularly intrinsic fluorescence spectroscopy, or infrared spectroscopy. Each of these techniques generates a spectrum which is digitized, thus providing a multidimensional digital signal representative of the sample being measured.

In other words, the invention comprises generating candidate models obtained by mixing intensity vectors, each representative of a taxon previously identified by means of the involved measurement techniques, and then retaining the candidate model which provides the best tradeoff between the approximation of the intensity vector of the sample submitted to the analysis and the complexity of the candidate model. It can indeed be observed that the model most faithfully estimating the biological sample is not that which allows the most accurate reconstruction of the intensity vector, but that which is both sufficiently accurate and of moderate complexity. The inventors have thus noted that an algorithm having such a structure enables both to detect the presence of a plurality of microorganisms in a sample and to identify the microorganisms present in the sample with a high success rate.

According to an embodiment of the invention, ∀(i,j)ε[[1,K]]², aᵢⱼ is a coefficient of similarity between reference vectors Pᵢ and Pⱼ of reference taxa yᵢ and yⱼ. Particularly, the similarity coefficients may be defined as scalar products between the intensity vectors, normalized or not or, when the reference vectors list peaks comprised in spectrums generated by the measurement technique, such as their Jaccard coefficients. It can indeed be observed that the biological proximity between two different taxa induces a proximity between the two reference vectors of these taxa. A microorganism of reference taxon yⱼ can thus be identified in a biological sample in addition to, or instead of, a microorganism of reference taxon yᵢ having a reference vector Pᵢ very close to reference vector Pⱼ of taxon yⱼ. The creation of adjusted reference vectors Pⱼ^{(a)}=Σᵢ₌₁^{K}aᵢⱼPᵢ taking into account the biological proximity between reference taxa thus minimizes detection and identification errors.

According to an embodiment, ŷ₀=0, and the construction of set {\hat{γ}ₗ} of candidate models \hat{γ}ₗ=(ŷ,0)ₗ comprises solving a set of optimization problems for values of a parameter λ of Rₗ, each problem being defined according to relation:

$$\hat{γ} ( λ ) = {argmin}_{γ ∈ {R}_{+}^{K}} ( {‖ x - {\sum }_{j = 1}^{K} {γ}_{j} {P}_{j}^{( a )} ‖}^{2} + λ {\vert γ \vert}_{1} )$$

in which expression |y|₁ is norm L1 of vector y.

In other words, the construction of the candidate models comprises a LASSO-type penalty involving a first term comprising construction error x−Σⱼ₌₁^{K}yⱼPⱼ^{(a)} and a second weighting term |y|₁ based on norm L1. For a zero term λ, the obtained candidate model is that which minimizes the reconstruction error under a constraint of positivity of the model coefficients. As mentioned hereabove, this model is generally not that which best estimates the biological sample since it usually has the highest complexity due to most or even all of components ŷⱼ being non-zero. As parameter λ increases, it can be observed that components ŷⱼ become equal to zero one by one and one after the others. By going through the values of λ, a set of candidate models each having a unique structure of ŷ is thus obtained. The application of this type of algorithm thus enables to perform a preselection of a small number of model structures from among the 2^{K} possible model structures. Since, besides, each optimization problem is convex, it is possible to very rapidly calculate the candidate models. A substantial acceleration of the method according to the invention is thus obtained.

As a variation, scalar y₀ is non-zero, and the above-described optimization problem can be rewritten according to relation:

$$( \hat{γ} ( λ ) , {\hat{γ}}_{0} ( λ ) ) = {argmin}_{γ ∈ {R}_{+}^{κ} , {γ}_{0} ∈ {R}_{+}} ( {‖ x - ( {\sum }_{j = 1}^{K} {γ}_{j} {P}_{j}^{( a )} + {γ}_{0} {I}_{p} ) ‖}^{2} + λ {\vert γ \vert}_{1} )$$

Different structures can thus be selected.

According to another embodiment, y₀=0, and the construction of set {\hat{γ}ₗ} of candidate models \hat{γ}ₗ=(ŷ,0)ₗ comprises solving a set of optimization problems for values of parameters λ and β of Rₗ, each problem being defined according to relation:

$$\hat{γ} ( λ , β ) = {argmin}_{γ ∈ {R}_{+}^{K}} ( {‖ x - {\sum }_{j = 1}^{K} {γ}_{j} {P}_{j}^{( a )} ‖}^{2} + λ {\vert {w}_{1} ⊙ γ \vert}_{1} + β {\vert {w}_{2} ⊙ γ \vert}_{2} )$$

in which expression:
   | l₁ is norm L1;
   | l₂ is norm L2;
a⊙b is the term-by-term product of vectors a and b; and
w₁ and w₂ are vectors of predetermined weight of Rₗ^{K}.

In other words, the construction of the candidate models by the LASSO method is implemented by means of a LARS-EN-type algorithm (for “Least Angle Regression Elastic Net”) with a penalty of “elastic net” type (β=0) combined with an adaptive penalty (w₁=w₂=I_{K}). The LARS-EN algorithm for example is Zou and Hastie's which is comprised in module “R elastieNet” available at address http://cran.rproject.org/web/packages/elasticnet/. As a variation, only the “elastic net” type penalty is implemented, that is, β is set to be zero, or only the adaptive LASSO-type penalty is implemented, that is, w₁ and w₂ are set to be equal to unit vector I_{K} of R^{K}. Different structures for the candidate models may be obtained. Advantageously, the adaptive version enables to include beforehand information relative to the taxa which are likely to be contained in the biological sample. For example, selecting a component of vectors w₁, w₂ smaller than the other components enables to make the presence of the taxon corresponding to this component in the biological sample more likely.

As a variation, scalar ŷ₀ is non-zero, and the above-described optimization problem can be rewritten according to relation:

$$( \hat{γ} ( λ , β ) , {\hat{γ}}_{0} ( λ , β ) ) = {argmin}_{γ ∈ {R}_{+}^{K} , {γ}_{0} ∈ {R}_{+}} ( {‖ x - ( {\sum }_{j = 1}^{K} {γ}_{j} {P}_{j}^{( a )} + {γ}_{0} {I}_{p} ) ‖}^{2} + λ {\vert {w}_{1} ⊙ γ \vert}_{1} + β {\vert {w}_{2} ⊙ γ \vert}_{2} )$$

Other approaches allowing a preselection other than a LARS-EN algorithm may be envisaged, such as for example a simple or structured “stepwise” algorithm, such as for example described in document “Structured, sparse regression with application to HIV drug resistance” by Daniel Percival et al., Annals of Applied Statistics, 2011, vol. 5, No. 2A, 628-644, or even an exhaustive approach aiming at evaluating a significant number of structures of candidate models among the possible structures.

Advantageously, for each vector ŷ which is the solution of an optimization problem, a new candidate model \hat{γ}ₗ=(ŷ^{lm},ŷ₀^{lm})ₗ is calculated, and replaces model \hat{γ}ₗ=(ŷ,0)ₗ corresponding to vector ŷ, the components of vector ŷ^{lm} of the new model \hat{γ}ₗ=(ŷ^{lm},ŷ₀^{lm})ₗ, corresponding to the zero components of vector ŷ, being forced to zero, and the new model \hat{γ}ₗ=(ŷ^{lm},ŷ₀^{lm})ₗ being calculated by solving the optimization problem according to relations:

$$( {\hat{γ}}^{lm} , {\hat{γ}}_{0}^{lm} ) = {argmax}_{{{γ}_{0}^{lm} ∈ {R}_{+}}_{{γ}^{lm} ∈ {R}_{+}^{K}}} ( - \frac{p}{2} ln ( 2 {πσ ( {x}_{l} )}^{2} ) - \frac{1}{2 {σ ( {x}_{l} )}^{2}} {\sum }_{b = 1}^{p} {( {x}_{b} - {x}_{lb} )}^{2} )$$

$${σ ( {x}_{l} )}^{2} = \frac{1}{p} {\sum }_{b = 1}^{p} {( {x}_{b} - {x}_{lb} )}^{2}$$

$${x}_{l} = {γ}_{0}^{lm} {I}_{p} + {\sum }_{j \text{:} {\hat{γ}}_{j} = 0} {γ}_{j}^{lm} {P}_{j}^{( a )}$$

in which expression:
x_{b} is the b^{th} component of the intensity vector of biological sample x; and

x_{1b} is the b^{th} component of reconstruction vector xₗ=y₀^{lm}Iₚ+Σ_{jŷj>0}yⱼ^{lm}Pⱼ^{(a)}.

In other words, the candidate models are recalculated by a standard linear model while keeping the structures of vectors obtained at the end of the implementation of the LASSO approach or the like. Due to the weighting of the reconstruction error by a term based on norm L1, the candidate models obtained by a LASSO approach have a low likelihood, although they exhibit relevant structures. The candidate models are advantageously recalculated by keeping the structures determined by the LASSO approach and by maximizing their likelihood as defined in a standard linear model. The quality of the analysis of the biological sample is thus reinforced since the selection of the candidate models and the estimation of their effect are carried out in two different steps.

According to an embodiment, criterion Cᵥ(\hat{γ}ₗ) quantifying the reconstruction error is a likelihood criterion. More specifically:

$${C}_{v} ( {\hat{γ}}_{l} ) = - \frac{p}{2} ln ( 2 π {\hat{σ}}^{2} ) - \frac{1}{2 {\hat{σ}}^{2}} {\sum }_{b = 1}^{p} {( {x}_{b} - {\hat{x}}_{lb} )}^{2}$$

in which expression:

$${\hat{σ}}^{2} = \frac{1}{p} {\sum }_{b = 1}^{p} {( {x}_{b} - {\hat{x}}_{lb} )}^{2} ;$$

x_{b} is the b^{th} component of the intensity vector of biological sample x; and
\hat{x}_{lb} is the b^{th} component of reconstruction vector \hat{x}ₗ of candidate model \hat{γ}ₗ.

According to an embodiment, criterion C_{c}(\hat{γ}ₗ) quantifying the complexity of model \hat{γ}ₗ quantifies said complexity in terms of number of strictly positive components ŷⱼ of vector ŷ. More specifically:

$$\begin{matrix}If {\hat{γ}}_{0} = 0 then & {C}_{c} ( {\hat{γ}}_{l} ) = ( 1 + {\sum }_{j = 1}^{K} 1 ( {\hat{γ}}_{j} > 0 ) ) ln p \\ If {\hat{γ}}_{0} \neq 0 then & {C}_{c} ( {\hat{γ}}_{l} ) = ( 2 + {\sum }_{j = 1}^{K} 1 ( {\hat{γ}}_{j} > 0 ) ) ln p\end{matrix}$$

in which expression function 1(.) is equal to 1 if its argument is true and zero otherwise.

As a variation, when scalar ŷ₀ is set to be equal to zero on calculation of the candidate models, and thus also scalar y₀^{lm}, criterion C_{c}(\hat{x}ₗ) can be rewritten according to relation:

$${C}_{c} ( {\hat{γ}}_{l} ) = ( 1 + {\sum }_{j = 1}^{K} 1 ( {\hat{γ}}_{j} > 0 ) ) ln p$$

Thus, according to a preferred embodiment, the selected candidate model ŷₛₑₗ is that which minimizes the function according to relation:

$$- \frac{p}{2} ln ( 2 π {\hat{σ}}^{2} ) - \frac{1}{2 {\hat{σ}}^{2}} {\sum }_{b = 1}^{p} {( {x}_{b} - {\hat{x}}_{lb} )}^{2} + ( 2 + {\sum }_{j = 1}^{K} 1 ( {\hat{γ}}_{j} > 0 ) ) ln p$$

or the function according to relation:

$$- \frac{p}{2} ln ( 2 π {\hat{σ}}^{2} ) - \frac{1}{2 {\hat{σ}}^{2}} {\sum }_{b = 1}^{p} {( {x}_{b} - {\hat{x}}_{lb} )}^{2} + ( 1 + {\sum }_{j = 1}^{K} 1 ( {\hat{γ}}_{j} > 0 ) ) ln p$$

In other words, the selected candidate model is that which minimizes a “BIC” (acronym for “Bayesian Information Criterion”) criterion which provides a high-performance model selection. Reference may for example be made to document “Le critère BIC: fondements théoriques et intërpretation”, by Emilie Labarbier and Tristan Mary-Huard, INRIA, Rapport de recherche no 5315, September 2004, for a more detailed description of this criterion.

Other selection criteria are however possible, such as for example an “AIC” (acronym for “Akaike Information Criterion”), “MLD” (acronym for “Minimum Description Length”), or “Cp de Mallows” criterion, or generally any criterion combining a likelihood or error reconstruction criterion with a complexity criterion.

According to an embodiment, the taxa belong to a same taxonomic level, particularly the species, genus, or sub-species level. As a variation, the taxa belong to at least two different taxonomic levels, particularly species, genera, and/or sub-species. Particularly, if a degree of similarity between a set of taxa defined within a first taxonomic level is greater than a predetermined threshold, then, for the forming of the predetermined set {yⱼ} of reference taxa, said taxa are gathered and replaced with a reference taxon defined at a second taxonomic level, higher than the first taxonomic level.

In other words, the method according to the invention is free of selecting different microorganism description levels. For example, it is possible to combine species with genera without for this to raise any particular issue. Due to the invention, it is thus possible to select reference taxa which sufficiently differ from one another regarding the reference vectors, and thus minimize detection and identification errors. For example, when the species spectrums within a same specific genus have very large degrees of similarity, thereby risking puzzling the detection or identification algorithm, it is possible to select genus rather than species, while still preferring the species level for the other microorganisms.

According to an embodiment, taxa belong to a first taxonomic level, and a new model of the vector is calculated by estimating the contribution of said taxa to a second taxonomic level, higher than the first taxonomic level, by adding the components of vector ŷ attached to said higher level. Particularly, the model of vector x is calculated for the higher taxonomic level if a degree of similarity within the first level is higher than a predetermined threshold.

In other words, due to the invention, it is possible to identify the higher taxonomic level of a microorganism due to the results obtained by the algorithm at the lower taxonomic level. This for example enables to keep an identical taxonomic level for all microorganisms, even in the case where microorganisms would exhibit a very high similarity at said level, and to compensate for detection and identification errors resulting therefrom by calculating a candidate model for the higher taxonomic level. This approach can also be applied to reference taxa considered at different levels, it being possible to calculate higher levels on demand, particularly when the candidate model finally selected comprises taxa considered very similar.

According an embodiment, the measurement technique generates a spectrum and reference intensity vectors Pⱼ are lists of peaks comprised in the spectrums of reference taxa yⱼ. Particularly, the measurement technique comprises a mass spectrometry.

According to an embodiment:

$${C}_{j} = \frac{{\hat{γ}}_{j , sel}}{{\sum }_{i = 1}^{K} {\hat{γ}}_{i , sel}}$$

in which expression ∀jε[[1,K]], ŷ_{j,sel} is the j^{th} component of vector ŷ of selected model ŷₛₑₗ.

The invention also aims at a device for analyzing a biological sample comprising:
a spectrometer or a spectroscope capable of generating spectrums of the biological sample;
a calculation unit capable of implementing a method of the above-mentioned type.

### BRIEF DESCRIPTION OF THE DRAWINGS

The invention will be better understood on reading of the following description provided as an example only in relation with the accompanying drawings, among which:

FIG. 1 is a flowchart illustrating a method according to the invention;

FIGS. 2A and 2B respectively are a matrix of similarity between a plurality of bacterium species used to test the method according to the invention and peak vectors of mixtures of said bacteria; and

FIGS. 3A and 3B respectively are results of the detection and of the identification according to the invention respectively performed at the species level and at the genus level on the mixtures.

### DETAILED DESCRIPTION

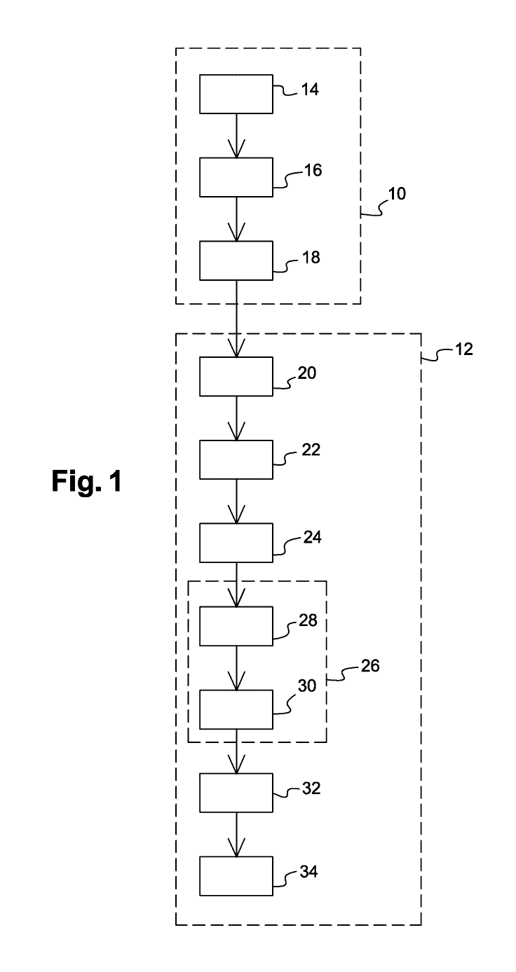

An embodiment of the invention applied to the MALDI-TOF (“Matrix-assisted laser desorption/ionization time of flight”) mass spectrometry and for a single taxonomic level, that is, the species level, will now be described in relation with the flowchart of FIG. 1. MALDI-TOF mass spectrometry is well known per se and will not be described in further detail hereafter. Reference may for example be made to Jackson O. Lay's document, “Maldi-tof spectrometry of bacteria”, Mass Spectrometry Reviews, 2001, 20, 172-194.

The method starts with a step 10 of construction of a set {Pⱼ}={P₁ P₂ . . . P_{K}} of K reference intensity vectors Pⱼ, each associated with a previously identified microorganism reference species yⱼ, and carries on with a step 12 of analyzing a biological sample for which it is desired to know whether it comprises one or a plurality of different reference species and/or for which the reference species that it is likely to contain are desired to be identified and/or for which the abundance of the microorganisms present in the sample is desired to be quantified.

An embodiment of step 10 is now described for a reference species yⱼ. Step 10 comprises acquiring, at 14, at least one digital mass spectrum of species yⱼ in a predetermined Thomson range [mₘᵢₙ; mₘₐₓ] by a MALDI-TOF spectrometry. For example, a plurality of strains of a microorganism belonging to species yⱼ is used and a spectrum is acquired for each of the strains. The digital spectrums acquired for species yⱼ are then pre-processed, advantageously after a logarithmic transformation, especially to denoise them and remove their baseline, in a way known per se.

The peaks present in the acquired spectrum are then identified at step 16, for example, by means of a peak detection algorithm based on the detection of local maximum values. A list of peaks for each acquired spectrum, comprising the location and the intensity of the spectrum peaks, is thus generated.

The method carries on, at step 18, by a quantization or “binning” step. To achieve this, Thompsons range [mₘᵢₙ; mₘₐₓ] is divided into p intervals, or “bins”, of predetermined widths, for example, identical. Each list of peaks is decreased by retaining a single peak per interval, for example, the peak having the strongest intensity. Each list is thus reduced to a vector of R^{p} having as a component the intensity of the peaks retained for the quantization intervals, the zero value for a component meaning that no peak has been detected, and thus kept, in the corresponding interval. A multidimensional digital vector PⱼεR^{p}, also called “prototype”, is then produced for species yⱼ according to the reduced peak lists. Each component of vector Pⱼ is especially set to be zero if the frequency of the corresponding components of the decreased lists which are strictly positive is lower than a threshold, for example, 30%, and otherwise selected to be equal to the median value of the corresponding components of the reduced lists which are strictly positive or equal to the average of the corresponding components of the reduced lists.

Particularly, for MALDI-TOF spectrometry, [mₘᵢₙ;mₘₐₓ]=[3,000;17,000]. It has indeed been observed that the data sufficient to identify the microorganisms are grouped in this mass-to-load ratio range and that it is not necessary to take a wider range into account. Range [mₘᵢₙ;mₘₐₓ] is divided into p=1,300 constant intervals. Vector Pⱼ thus is a vector of R¹³⁰⁰. As a variation, the width of the intervals logarithmically increases, as described in application EP 2 600 385.

As a variation, vector Pⱼ is “binarized” by setting the value of a component of vector Pⱼ to “1” when a peak is present in the corresponding interval, and to “0” when no peak is present in this interval. This results in making the analysis of the biological sample of step 12 more robust. The inventors have indeed noted that the relevant information, particularly to identify a bacterium, is essentially contained in the absence and/or the presence of peaks and that the intensity information is less relevant. It can further be observed that the intensity is highly variable from one spectrum to the other and/or from one spectrometer to the other. Due to this variability, it is difficult to take into account raw intensity values in the classification tools.

Of course, vector Pⱼ of species yⱼ may be obtained in any way deemed useful to generate a vector representative of species yⱼ. For example, the spectrums of the strains of species yⱼ are submitted to a statistic processing to generate a single spectrum. The single spectrum is the submitted to a peak detection and the generated list of peaks is then quantized by only keeping in each quantization interval the peak of strongest intensity. The statistic processing may for example be the calculation of the average of the spectrums, the calculation of a median spectrum, or the selection of the spectrum which exhibits the average distance to all the other spectrums of the weakest species. Similarly, quantization step 18, which enables to significantly decrease the number of data to be processed while guaranteeing an algorithmic robustness, is optional. Vector Pⱼ may for example be formed of the digital spectrum directly obtained after acquisition and pre-processing step 14. Generally, any method enabling to generate for species yⱼ a digital vector comprising a single signature of this species may be suitable.)

Vectors {Pⱼ} obtained by construction step 10 are then stored in a database. The database is then incorporated in a system of biological sample analysis by mass spectrometry comprising a mass spectrometer, of MALDI-TOF type, as well as a data processing unit, connected to the spectrometer and capable of receiving, digitizing, and processing the acquired mass spectrums by implementing analysis step 12. The analysis system may also comprise a data processing unit distant from the mass spectrometer. For example, the digital analysis is performed on a distant server accessible by a user by means of a personal computer connected to the Internet, to which the server is also connected. The user loads non-processed digital mass spectrums obtained by a MALDI-TOF type mass spectrometer onto the server, which then implements the analysis algorithm and returns the results of the algorithm to the user's computer. It should be noted that the database, particularly that embarked in the analysis system, may be updated at any moment, particularly to add, replace, and/or remove a reference intensity vector.

An embodiment of step 12 of analysis of a biological sample for which it is desired to know whether it comprises one or a plurality of types of microorganism and/or for which the microorganism(s) that it contains are desired to be identified and/or for which the relative abundance of a plurality of microorganisms present in the sample is desired to be quantified will now be described.

Analysis step 12 comprises a first step 20 of preparing the biological sample for MALDI-TOF spectrometry, particularly the incorporation of the sample in a matrix, as known per se. More particularly, the sample undergoes no preliminary step aiming at isolating the different types of microorganisms that it contains.

Analysis 12 carries on with a step 22 of acquiring a digital mass spectrum of the biological sample with a MALDI-TOF spectrometer and the acquired spectrum is denoised and its baseline is removed.

A next step 24 comprises detecting the peaks of the digital spectrum and determining an intensity vector x of V based on the detected peaks. For example, a quantization of the Thomson space such as previously described is implemented by only keeping the peak of highest intensity in a quantization interval. Generally, intensity vector x may be generated by any appropriate method.

Once intensity vector x of R^{p} has been obtained according to the mass spectrum of the biological sample, the analysis carries on at 26, by the construction of a set {\hat{γ}ₗ} of candidate models \hat{γ}ₗ=(ŷₗ,ŷ₀)ₗ modeling intensity vector x according to relation:

$${\hat{x}}_{l} = {\sum }_{j = 1}^{K} {\hat{γ}}_{j} {P}_{j}^{( a )} + {\hat{γ}}_{0} {I}_{p} \qquad ( 1 )$$

in which expression:
\hat{x}ₗ is a vector of R reconstructing intensity vector x with model \hat{γ}ₗ;
K is the number of reference intensity vectors Pⱼ stored in the database;
ŷ₀ is a real scalar and lₚ=(1 1 . . . 1)^{r} is the unit vector of R^{p};
∀jε[[1,K]], ŷⱼ is the j^{th} component of a vector ŷ of Rₗ^{K};
∀jε[[1,K]], Pⱼ^{(a)}=Σᵢ₌₁^{K}aᵢⱼPᵢ; and
∀(i,j)ε[[1,K]]², aᵢⱼ is a predetermined coefficient.

More particularly, coefficients aᵢⱼ are coefficients quantifying the similarity, or the “proximity” between reference intensity vectors Pⱼ, particularly, Jaccard coefficients according to relation:

$${a}_{ij} = \frac{{N}_{ij}^{C}}{( {N}_{i} + {N}_{j} ) - {N}_{ij}^{C}} \qquad ( 2 )$$

where Nᵢ is the number of non-zero components of vector P₀. Nⱼ is the number of non-zero components of vector Pⱼ, and Nᵢⱼ^{C} is the number of non-zero components shared by vectors Pᵢ and Pⱼ.

More particularly, construction 26 of set {\hat{γ}ₗ} comprises a first step 28 of selecting a set {\tilde{y}} of structuress \tilde{y} of increasing complexity for vectors ŷ of candidate models \hat{γ}ₗ, followed by a step 30 of calculating candidate models having the selected structures of \tilde{y}.

Particularly, step 28 comprises selecting a set {\tilde{y}} of binary vectors \tilde{y} of R^{K} comprising an increasing number of zero components, each vector \tilde{y} indicating what components of vector ŷ of a candidate model \hat{x}ₗ are free or forced to 0. Particularly, a component of value 0 of vector \tilde{y} indicates that the corresponding component of vector ŷ is forced to 0, and a component of value 1 of vector \tilde{y} indicates that the corresponding component of vector ŷ is free to take a non-zero positive value. For example, by setting p=3, and by selecting a vector \tilde{y}=(1 0 1)^{T}, it is determined that a candidate model \hat{x}ₗ will be calculated by having the second component of vector ŷ forced to zero and the first and third components of vector ŷ free to take non-zero positive values.

Advantageously, structures \tilde{y} of vectors ŷ are selected by implementing a LASSO approach or “penalty”, that is, by solving a set of optimization problems for values of a parameter λ of Rₗ, each problem being defined according to relation:

$$( \hat{γ} ( λ ) , {\hat{γ}}_{0} ( λ ) ) = {argmin}_{γ ∈ {R}_{+}^{K} , {γ}_{0} ∈ {R}_{+}} ( {‖ x - ( {\sum }_{j = 1}^{K} {γ}_{j} {P}_{j}^{( a )} + {γ}_{0} {I}_{p} ) ‖}^{2} + λ {\vert γ \vert}_{1} ) \qquad ( 3 )$$

in which expression |y|₁ is norm L1 of vector y.

Particularly, starting from λ=0, corresponding to a vector ŷ(0) having each of its component free to take any positive or zero value, as parameter λ increases, the LASSO penalty sets to zero, one by one, the components of vector ŷ(λ) to obtain a zero vector ŷ(λ). A small number, that is, much smaller than 2^{K}, most often close or equal to K, of vectors ŷ(λ) of different structures \tilde{y}(λ), is thus obtained. Further, the LASSO approach aiming at minimizing reconstruction error ∥x−(Σⱼ₌₁^{K}yⱼPⱼ^{(a)}+y₀Iₚ))∥ under constraint, each of the selected structures represents a relevant structure, or even the best structure, for its complexity, that is, the number of its zero components.

The LASSO approach and its variations, such as the “elastic net” penalty, are for example implemented by means of Zou and Hastie's LARS-EN algorithm, which is comprised in the “R elasticNet” module available at address http://cran.r-project.org/web/packages/elasticnet/.

For each selected structure \tilde{y}, step 30 of calculating candidate model \hat{γ}ₗ having a vector ŷ according to structure \tilde{y} comprises preferably maximizing a likelihood criterion between reconstruction vector \hat{x}ₗ of model \hat{γ}ₗ and the intensity vector x of the bicilogical sample. Particularly, candidate model \hat{γ}ₗ=(ŷ,ŷ₀) is calculated by solving the optimization problem according to relations:

$$\begin{matrix}( \hat{γ} , {\hat{γ}}_{0} ) = {argmax}_{{{γ}_{0} ∈ {R}_{+}}_{γ ∈ {R}_{+}^{K}}} ( - \frac{p}{2} ln ( 2 {πσ ( {x}_{l} )}^{2} ) - \frac{1}{2 {σ ( {x}_{l} )}^{2}} {\sum }_{b = 1}^{p} {( {x}_{b} - {x}_{lb} )}^{2} ) & ( 4 ) \\ {σ ( {x}_{l} )}^{2} = \frac{1}{p} {\sum }_{b = 1}^{p} {( {x}_{b} - {x}_{lb} )}^{2} & ( 5 ) \\ {x}_{l} = {γ}_{0} {I}_{p} + {\sum }_{j = 1}^{K} {( \tilde{γ} ⊙ γ )}_{j} {P}_{j}^{( a )} & ( 6 )\end{matrix}$$

in which expression:
a⊙b is the term-by-term product of vectors a and b;
x_{b} is the b^{th} component of the intensity vector of biological sample x; and

x_{1b} is the b^{th} component of reconstruction vector xₗ.

Equivalently, when structures \tilde{y} are determined by the LASSO approach of relation (3), candidate model ŷₗ=(ŷ^{lm},ŷ₀^{lm})ₗ has the components of its vector ŷ=ŷ^{lm} forced to 0 when the corresponding components of vector \tilde{y} are equal to 0, which corresponds to a reconstruction vector \hat{x}ₗ which can be rewritten as \hat{x}ₗ=ŷ₀^{lm}lₚ+Σ_{jl,ŷ}_{ⱼ}_{>a}ŷⱼ^{im}Pⱼ^{(a)}. The optimization problem of relations (4), (5), (6) can then be rewritten according to relations:

$$\begin{matrix}( {\hat{γ}}^{lm} , {\hat{γ}}_{0}^{lm} ) = {argmax}_{{{γ}_{0}^{lm} ∈ {R}_{+}}_{{γ}^{lm} ∈ {R}_{+}^{K}}} ( - \frac{p}{2} ln ( 2 {πσ ( {x}_{l} )}^{2} ) - \frac{1}{2 {σ ( {x}_{l} )}^{2}} {\sum }_{b = 1}^{p} {( {x}_{b} - {x}_{lb} )}^{2} ) & ( 4 bis ) \\ {σ ( {x}_{l} )}^{2} = \frac{1}{p} {\sum }_{b = 1}^{p} {( {x}_{b} - {x}_{lb} )}^{2} & ( 5 ) \\ {x}_{l} = {γ}_{0}^{lm} {I}_{p} + {\sum }_{j \text{:} {\hat{γ}}_{j} \neq 0} {γ}_{j}^{lm} {P}_{j}^{( a )} & ( 6 bis )\end{matrix}$$

in which expression jₗŷⱼ≠0 means the components j of vector ŷ calculated by the LASSO approach which are non-zero, and thus strictly positive.

Once set {\hat{γ}ₗ} of candidate models \hat{γ}ₗ has been calculated, step 12 of analyzing the biological sample carries on with a step 32 of selecting a candidate model ŷₛₑₗ=(ŷₛₑₗ,ŷ₀ₛₑₗ) from among set {\hat{γ}ₗ}, the selected candidate model ŷₛₑₗ being that considered as the most relevantly estimating intensity vector x of the analyzed biological sample.

More specifically, the selection of candidate model ŷₛₑₗ comprises selecting the model which provides the best tradeoff between the approximation of vector x and the complexity of the structure of the model. To achieve this, model ŷₛₑₗ is that which minimizes a criterion mixing a criterion Cᵥ(\hat{γ}ₗ) quantifying the reconstruction error of the estimate, or reconstruction, of vector x and a criterion C_{c}(\hat{γ}ₗ) quantifying the complexity of the estimate, and particularly the number of non-zero components of vector ŷ. Advantageously, model ŷₛₑₗ is selected by minimizing a “BIC” criterion, model ŷₛₑₗ being the solution of the optimization problem according to relation;

$$\begin{matrix}{\hat{γ}}_{sel} = {argmin}_{{\hat{γ}}_{l} ∈ \{ {\hat{γ}}_{l} \}} ( {C}_{v} ( {\hat{γ}}_{l} ) + {C}_{c} ( {\hat{γ}}_{l} ) ) & ( 7 ) \\ {C}_{v} ( {\hat{γ}}_{l} ) = - \frac{p}{2} ln ( 2 π {\hat{σ}}^{2} ) - \frac{1}{2 {\hat{σ}}^{2}} {\sum }_{b = 1}^{p} {( {x}_{b} - {\hat{x}}_{lb} )}^{2} & ( 8 ) \\ {C}_{c} ( {\hat{γ}}_{l} ) = ( 2 + {\sum }_{j = 1}^{K} 1 ( {\hat{γ}}_{j} > 0 ) ) ln p & ( 9 )\end{matrix}$$

in which expression function 1(.) is equal to 1 if its argument is true and zero otherwise and \hat{σ}²=σ(\hat{x}ₗ)².

Thus, candidate models \hat{γ}ₗ having been calculated by maximizing the likelihood criterion according to relation (5), they also maximize the likelihood criterion of relation (8). Further, the complexity of candidate models \hat{γ}ₗ involves the number of components of their non-zero vectors ŷ. It can be observed that the selection by means of this type of criterion is robust and relevant. Particularly, the finally-selected model ŷₛₑₗ is that which relevantly lists species yⱼ, respectively represented by components ŷⱼ of vector ŷ.

Analysis step 12 then carries on with the processing, at 34, of the selected model ŷₛₑₗ=(ŷₛₑₗ, ŷ₀ₛₑₗ) to deduce therefrom information relative to the analyzed biological sample.

More specifically, at least one of the following processings is implemented:
a. the biological sample is determined as comprising a plurality of different reference species of microorganisms if the number of components of vector ŷₛₑₗ which are greater than a positive or zero predetermined threshold value, is greater than or equal to 2;
b. the number of different reference species in the biological sample is calculated as being equal to the number of components of vector ŷₛₑₗ greater than a positive or zero predetermined threshold value;
c. a reference species yⱼ is identified in the biological sample when the j^{th} component of vector ŷₛₑₗ is greater than a predetermined positive or zero threshold value, the threshold value setting the sensitivity of the identification;
d. the relative abundance Cⱼ of a species yⱼ in the biological sample is calculated according to relation:

$${C}_{j} = \frac{{\hat{γ}}_{selj}}{{\sum }_{i = 1}^{K} {\hat{γ}}_{seli}} \qquad ( 10 )$$

where ŷₛₑₗⱼ is the j^{th} component of vector ŷₛₑₗ;
e. the results relating to reference species belonging to a same higher taxonomic level, particularly the genus thereof, are gathered by calculating a scalar ŷₛ^{sup} equal to the sum of the components of vector ŷₛₑₗ corresponding to said species. The higher taxonomic level is then identified if scalar ŷₛ^{sup} is greater than the predetermined positive or zero threshold value. Particularly, the j^{th} component of vector ŷₛₑₗ corresponding to each of the species belonging to the higher level may be smaller than the threshold value, in which case the species are not identified in the mixture, even though there actually exists in the biological sample at least one species belonging to the higher level. For example, when in a same genus gathering reference species y₁, y₂, y₃ which are difficult to differentiate by mass spectrometry, the presence only of specific reference species y₁ in the biological sample may result, rather than in a vector ŷₛₑₗ having its component corresponding to species y₁ which is non-zero and having its components corresponding to species y₂ and y₃ which are equal to zero, in a vector ŷₛₑₗ having its components corresponding to species y₁, y₂, y₃ are all non-zero but lower than the threshold value. By adding the components of these species, a value which exceeds the threshold and according a detection of the genus in the biological sample is obtained. As a variation, and additionally, by calculating scalar ŷₛ^{sup} for the higher level, the relative abundance of the higher level is calculated according to relation

$${C}_{sup} = \frac{{\hat{γ}}_{s}^{sup}}{{\sum }_{i = 1}^{K} {\hat{γ}}_{seli}} .$$

The gathering is advantageously performed automatically, particularly when it is observed that the species of a same taxonomic level, for example, the species belonging to a same genus, are very similar in terms of mass spectrum. Particularly, the similarity of the species is calculated, for example, by means of Jaccard coefficients of their reference intensity vector, and if the calculated similarity is higher than a threshold value, then the species results are automatically gathered.

The results of the processing are then stored in a computer memory, for example, that of the analysis device and/or displayed on a screen for the user.

A specific embodiment of the invention has been described. Many variations are however possible, particularly the following variations considered alone or in combination.

According to a variation, candidate models comprise no term on selection by the LASSO approach. Relation (1) can then be rewritten as:

$${\hat{x}}_{l} = {\sum }_{j = 1}^{K} {\hat{γ}}_{j} {P}_{j}^{( a )} \qquad ( 1 bis )$$

According to a variation, the candidate models \hat{γ}ₗ recalculated at step 30, that is, those used for the selection of final model ŷₛₑₗ, comprise no terms ŷ₀lₚ. Relations (4) to (11) can be easily deduced from this simplification. It should in particular be noted that relation (10) can be rewritten according to relation:

$${C}_{c} ( {\hat{γ}}_{l} ) = ( 1 + {\sum }_{j = 1}^{K} 1 ( {\hat{γ}}_{j} > 0 ) ) ln p \qquad ( 9 bis )$$

According to a variation, coefficients a_{i,j} are 1 when i=j and 0 when l≠j in which case relation (1) is reduced to relation:

$${\hat{x}}_{l} = {\sum }_{j = 1}^{K} {\hat{γ}}_{j} {P}_{j} + {\hat{γ}}_{0} {I}_{p} \qquad ( 1 ter )$$

According to a variation, coefficient a_{i,j} of similarity between two reference intensity vectors Pᵢ and Pⱼ is the scalar product thereof.

According to a variation, the selection of structures \tilde{y} of vectors ŷ of candidate models \hat{γ}ₗ is performed by implementing algorithms derived from the LASSO approach of relation (3), particularly an optimization problem according to one of the following relations:

$$\begin{matrix}( \hat{γ} ( λ ) , {\hat{γ}}_{0} ( λ ) ) = {argmin}_{γ ∈ {R}_{+}^{K} , {v}_{0} ∈ {R}_{+}} ( {‖ x - ( {\sum }_{j = 1}^{K} {γ}_{j} {p}_{j}^{( a )} + {γ}_{0} {I}_{p} ) ‖}^{2} + λ {\vert {w}_{1} ⊙ γ \vert}_{1} ) & ( 3 bis ) \\ ( \hat{γ} ( λ , β ) , {\hat{γ}}_{0} ( λ , β ) ) = {argmin}_{γ ∈ {R}_{+}^{K} , {v}_{0} ∈ {R}_{+}} ( {‖ x - ( {\sum }_{j = 1}^{K} {γ}_{j} {p}_{j}^{( a )} + {γ}_{0} {I}_{p} ) ‖}^{2} + λ {\vert γ \vert}_{1} + β {\vert γ \vert}_{2} ) & ( 3 ter ) \\ ( \hat{γ} ( λ , β ) , {\hat{γ}}_{0} ( λ , β ) ) = {argmin}_{γ ∈ {R}_{+}^{K} , {v}_{0} ∈ {R}_{+}} ( ‖ x - {( {\sum }_{j = 1}^{K} {γ}_{j} {p}_{j}^{( a )} + {γ}_{0} {I}_{p} ) ‖}^{2} + λ \vert {w}_{1} ⊙ γ {\vert}_{1} + β \vert {w}_{2} ⊙ γ {\vert}_{2} ) & ( 3 q )\end{matrix}$$

in which expressions:
β is a positive real parameter;
   |l_{z} is norm L2; and
w₁ and w₂ are vectors of predetermined weight of Rₗ^{K}.

According to a variation, the selection of structures \tilde{y} of vectors ŷ is performed by means an algorithm of simple or structured “stepwise” type, such as for example the algorithm described in document “Structured, sparse regression with application to HIV drug resistance” by Daniel Percival et al., Annals of Applied Statistics 2011, Vol. 5, No. 2A, 628-644, or of an exhaustive approach comprising testing a significant number, or even all, or the possible structures for vector ŷ.

According to a variation, step 30 of calculating the candidate models is omitted, the candidate models being those obtained at step 12, this selection step then being a step of calculating the candidate models with the LASSO algorithm.

Similarly, embodiments where the microorganisms are referenced at the species level have been described.

As a variation, a plurality of different taxonomic levels are used, for example, at least two levels from among species, sub-species, and genus.

As a variation, other types of microorganism characterization are used, particularly clinical phenotypes, such as for example the Gram of the bacteria.

Similarly, embodiments applied to MALDI-TOF spectroscopy have been described. Other types of measurement are possible, the invention applying to mass spectrometry, particularly MALDI-TOF spectrometry and ESI-MS spectrometry, vibrational spectroscopy, particularly RAMAN spectroscopy, fluorescence spectroscopy, particularly intrinsic fluorescence spectroscopy, and infrared spectroscopy.

Results of analyses of biological samples obtained according to the invention will now be described. More particularly, an application to MALDI-TOF spectroscopy is considered. The microorganisms are referenced at the species level, the candidate models take the form of relation (1bis), coefficients a_{i,j} are the Jaccard coefficients of relation (2), the selection of structures \tilde{y} of vectors ŷ is performed by means of the LASSO algorithm of relation (3) by setting y₀=ŷ₀=0, the calculation of the candidate models is performed by means of relations (4bis), (5) and (6) with a ŷ₀ non forced to 0, and the selection of candidate model ŷₛₑₗ is performed according to relations (7), (8) and (9).

A set of K=20 species of reference bacterium yⱼ is considered, some being Gram positive and others being Gram negative, belonging to 9 different genera, certain species having been selected according to the difficulty to tell them out by mass spectrometry.

For each species, from 11 to 60 mass spectrums have been measured based on from 7 to 20 strains of the species. A set of 571 mass spectrums for 213 strains is thus formed.

The reference intensity vector Pⱼ of each species yⱼ is obtained by applying a constant quantization between 3,000 and 7,000 Thomson with a number p=1340 of intervals, and for each interval, a peak intensity is calculated as previously described at step 18 to obtain vector Pⱼ.

Biological samples have been created by mixing with different ratios two difference references species, particularly:
4 sets of biological samples, bearing references “A”, “B”, “C”, and “D”, comprising two species belonging to the same genus;
4 sets of biological samples, bearing references “E” and “F”, comprising two species belonging to different genera but having the same Gram type;
4 sets of biological samples, bearing references “G”, “H”, “I”, and “J”, comprising two species having different Grams.

More specifically, for each reference species constitutive of a mixture, two different strains of the species are first selected, after which, for each strain, a “pure” sample only comprising the strain is produced. To obtain a set of biological samples mixing two species, two pairs of pure samples of the two species are then mixed with ratios 1:0, 10:1, 5:1, 2:1, 1:1, 1:2, 1:5, 1:10, 0:1.

Two mass spectrums are then measured and digitized for each produced biological sample, resulting in a total of 360 spectrums, 80 of which correspond to pure samples. Each mass spectrum is processed to obtain an intensity vector x by applying the quantization implemented for the construction of the reference intensity vectors, and by retaining the peak of maximum intensity for each quantization interval.

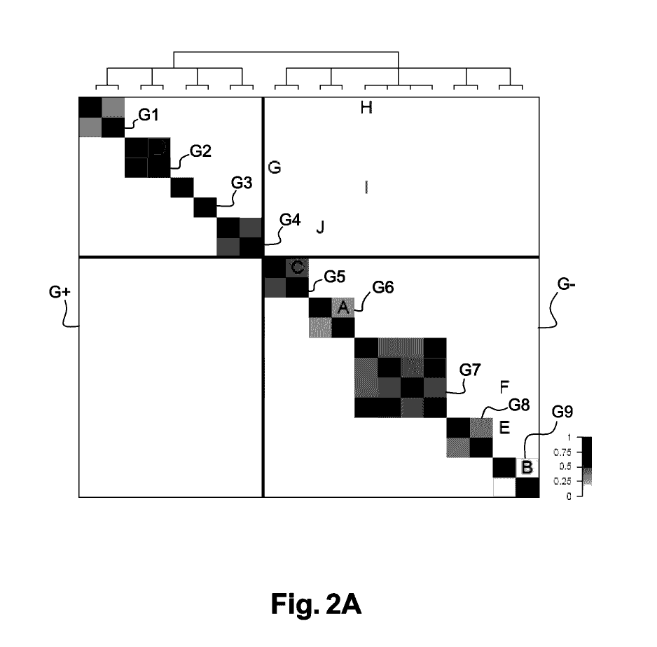

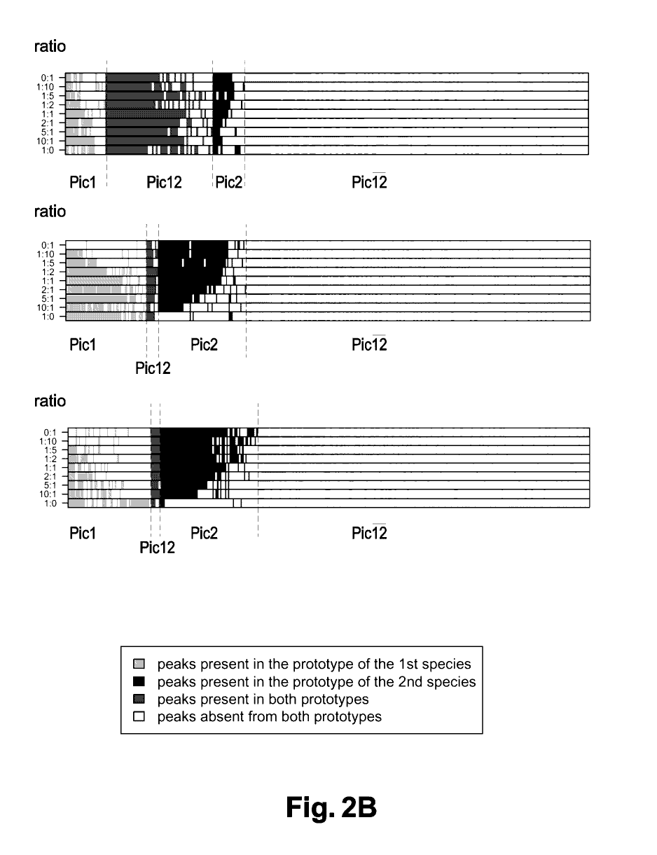

FIGS. 2A and 2B provide an illustration of the set of test data thus generated. FIG. 2A is a matrix of similarity of reference intensity vectors Pⱼ, the coefficients of the similarity matrix being Jaccard coefficients. The darker the component of the similarity matrix, the stronger the correlation between the corresponding species. Central squares G1-G9 correspond to the 9 considered genera, square G+ to Gram-positive bacteria, and square G− to Gram-negative bacteria. Sample sets A to J are further positioned on the similarity matrix. FIG. 2B illustrates the peaks of the spectrums of set D, that is, a mixture of two species belonging to the same genus, the peaks of the spectrums of set E, that is, a mixture of two species of bacteria having the same Gram, and the peaks of the spectrums of set I, that is, a mixture of two species of bacteria of different Grams. Each illustrated set comprises nine spectrums corresponding to the different above-described ratios, from ratio 1:0 corresponding to a pure sample of the first species to ratio 0:1 corresponding to a pure sample of the second species. The spectrums especially illustrate the peaks only present in the reference vector of the first species (peaks “Peak1”), the peaks only present in the reference vector of the second species (peaks “Peak2”), the peaks present both in the first and in the second species (peaks “Peak12”), and the peaks which are present neither in the first species, nor in the second species (peaks “Pic1̅2̅”). It should in particular be noted that for a mixture of two species of bacteria having the same genus, most of the peaks are present both in the reference vector of the two species, which means that it is difficult to differentiate them. It should also be noted that for the mixtures of two species of bacteria having the same Gram, the proportion of peaks of a species present in the spectrum of the mixture varies coherently with the ratio of this species, which is less true for mixtures of two species of bacteria having different Grams.

The capacity of the method according to the invention of detecting a polymicrobial mixture and of identifying its components has been evaluated by means of a sensitivity criterion and of a specificity criterion of the method, that is, respectively, the capacity of the method of detecting a mixture of two species and a “pure” mixture. Further, the following criteria are also evaluated: a) the detection of a microbial mixture is considered as successful when two or more components are detected; b) a mixture is considered as correctly identified when the two species forming the mixture, and only those, are identified; c) a mixture is considered as partially identified when one of the two species forming the mixture is identified; d) the identification of a mixture is considered as having failed when a species which does not belong to the mixture is identified.

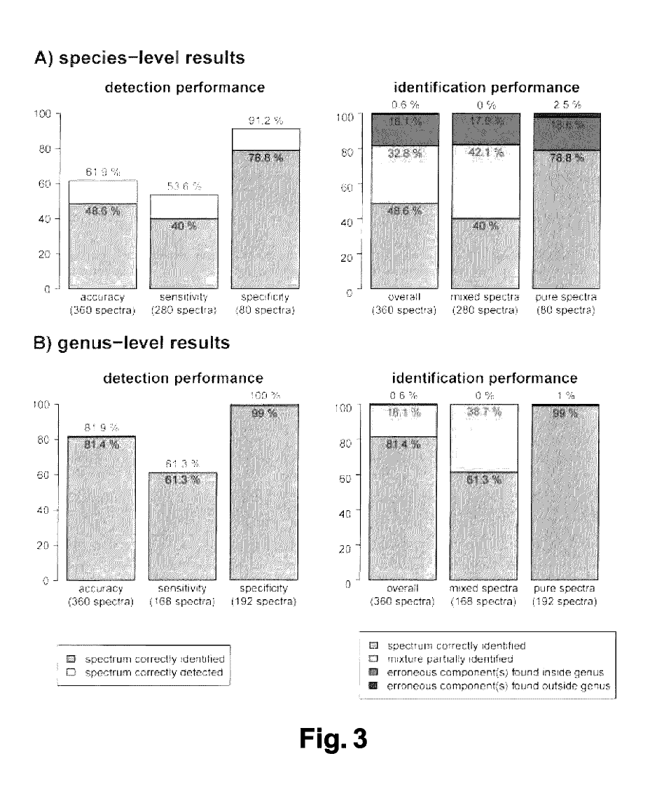

FIG. 3A illustrates the results obtained at the species level. In terms of detection (lefthand graph), it can be observed that 53.6% of the polymicrobial mixtures have been detected. However, 91.2% of the so-called “pure” mixtures, that is, comprising a single species, have been detected, and nearly 75% of the detected polymicrobial mixtures have been properly identified, this percentage rising up to 86.4% for pure mixtures. Further, regarding identification (right-hand graph), it should be noted that 42.1% of the polymicrobial mixtures have been partially identified, resulting in a successful partial identification in 82.1% of cases, and the identification has failed for approximately 18% of the polymicrobial mixtures and the pure mixtures altogether. A large majority of these failures corresponds to mixtures comprising species of the same genus, which corresponds to the difficulty of distinguishing bacteria which are taxonomically close.

The switching of the detection and of the identification to the higher taxonomic level, that is, genus, significantly improves the results as illustrated in FIG. 3B. The results for genera have been obtained by implementing the method according to the invention at the species level and then by adding the components of vectors ŷₛₑₗ to obtain results at the genus level, as previously described. The sensitivity and the specificity of the detection at the genus level respectively reach 61.3% and 100% for polymicrobial mixtures and pure mixtures, and all genera are substantially correctly identified. Further, the few mixtures which have not been correctly identified are partially identified. On the whole, 81.4% of the mixtures have been correctly identified, the identification having failed for only 0.6% thereof.

1. A method of detecting in a biological sample at least two microorganisms belonging to two different taxa from a predetermined set {yⱼ} of a number of K different reference taxa yⱼ, each reference taxon yⱼ being represented by a predetermined intensity vector Pⱼ of a space R^{p} obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample with the measurement technology;
determining an intensity vector x of R^{p} according to the acquired multidimensional digital signal;
constructing a set {\hat{γ}ₗ} of candidate models \hat{γ}ₗ=(ŷ,ŷ₀)ₗ modeling intensity vector x according to relation:
$${\hat{x}}_{l} = {\sum }_{j = 1}^{K} {\hat{γ}}_{j} {P}_{j}^{( a )} + {\hat{γ}}_{0} {I}_{p}$$
in which expression:
\hat{x}ₗ is a vector of R^{p} reconstructing intensity vector x with model \hat{γ}ₗ;
ŷ₀ is a real scalar and Iₚ is the unit vector of;
∀jε[[1,K]], ŷⱼ is the j^{th} component of a vector ŷ of Rₗ^{kp};
∀jε[[1,K]], Pⱼ^{(a)}=Σᵢ₌₁^{K}aᵢⱼPᵢ; and
∀(i,j)ε[[1,K]]², aᵢⱼ is a predetermined coefficient;
selecting a candidate model ŷₛₑₗ from set {\hat{γ}ₗ} of candidate models \hat{γ}ₗ, solution of a problem according to relation:
$${\hat{γ}}_{set} = {argmin}_{{\hat{γ}}_{l} ∈ ( {\hat{γ}}_{l} )} ( {C}_{v} ( {\hat{γ}}_{l} ) + {C}_{c} ( {\hat{γ}}_{l} ) )$$
in which expression:
Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and
C_{c}(\hat{γ}ₗ) is a criterion quantifying the complexity of a candidate model \hat{γ}ₗ;
and determining the presence in the biological sample of at least two microorganisms belonging to different taxa of predetermined set {yⱼ} of taxa when at least two components ŷⱼ of vector ŷ of the selected candidate model ŷₛₑₗ are greater than a strictly positive predetermined threshold value.

2. A method of identifying microorganisms present in a biological sample from a predetermined set {yⱼ} of a number of K different reference taxa, each reference taxon yⱼ being represented by a predetermined intensity vector Pⱼ of a space obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample with the measurement technology;
determining an intensity vector x of R^{p} according to the acquired multidimensional digital signal;
constructing a set {\hat{γ}ₗ} of candidate models \hat{γ}ₗ=(ŷ,ŷ₀)ₗ modeling intensity vector x according to relation:
$${\hat{x}}_{l} = {\sum }_{j = 1}^{K} {\hat{γ}}_{j} {p}_{j}^{( a )} + {\hat{γ}}_{0} {I}_{p}$$
in which expression:
\hat{x}ₗ is a vector of R^{p} reconstructing intensity vector x with model \hat{γ}ₗ;
ŷ₀ is a real scalar and Iₚ is the unit vector of R^{p};
∀jε[[1,K]], ŷⱼ is the j^{th} component of a vector ŷ of Rₗ^{lK};
∀jε[[1,K]], Pⱼ^{(a)}=Σᵢ₌₁^{K}aᵢⱼPᵢ; and
∀(i,j)ε[[1,K]]², aᵢⱼ is a predetermined coefficient;
selecting a candidate model \hat{x}ₛₑₗ from set {\hat{x}ₗ} of candidate models \hat{x}ₗ, solution of a problem according to relation:
$${\hat{x}}_{set} = {argmin}_{{\hat{x}}_{l} ∈ ( {\hat{x}}_{l} )} ( {C}_{v} ( {\hat{x}}_{l} ) + {C}_{c} ( {\hat{x}}_{l} ) )$$
in which expression:
Cᵥ(\hat{x}ₗ) is a criterion quantifying a reconstruction error between the intensity vector of biological sample x and a candidate model \hat{x}ₗ; and
C_{c}(\hat{x}ₗ), is a criterion quantifying the complexity of a candidate model \hat{x}ₗ;
and determining the presence in the biological sample of a microorganism of taxon yⱼ of the predetermined set {yⱼ} for each component ŷⱼ of vector ŷ of the selected candidate model greater than a strictly positive predetermined threshold value.

3. A method of detecting the relative abundance in a biological sample at least two microorganisms belonging to two different taxa from a predetermined set {yⱼ} of a number of K different reference taxa yⱼ, each reference taxon yⱼ being represented by a predetermined intensity vector Pⱼ of a space R^{p} obtained by submitting at least one reference biological sample comprising a microorganism exhibiting the reference taxon to a measurement technique generating a multidimensional digital signal representative of the reference sample and by determining said reference vector according to said multidimensional digital signal, where p is greater than 1, the method comprising:
acquiring a multidimensional digital signal of the biological sample with the measurement technology;
determining an intensity vector x of R^{p} according to the acquired multidimensional digital signal;
constructing a set {\hat{γ}ₗ} of candidate models \hat{γ}ₗ=(ŷ,ŷ₀)ₗ modeling intensity vector x according to relation:
$${\hat{x}}_{l} = {\sum }_{j = 1}^{K} {\hat{γ}}_{j} {p}_{j}^{( a )} + {\hat{γ}}_{0} {I}_{p}$$
in which expression:
\hat{x}ₗ is a vector of R^{p} reconstructing intensity vector x with model \hat{γ}ₗ;
ŷ₀ is a real scalar and Iₚ is the unit vector of R^{p};
∀jε[[1,K]], ŷⱼ is the j^{th} component of a vector ŷ of Rₗ^{lK};
∀jε[[1,K]], Pⱼ^{(a)}=Σᵢ₌₁^{K}aᵢⱼPᵢ; and
∀(i,j)ε[[1,K]]², aᵢⱼ is a predetermined coefficient;
selecting a candidate model ŷₛₑₗ from set {\hat{γ}ₗ} of candidate models \hat{γ}ₗ, solution of a problem according to relation:
$${\hat{γ}}_{set} = {argmin}_{{\hat{γ}}_{l} ∈ ( {\hat{γ}}_{l} )} ( {C}_{v} ( {\tilde{γ}}_{l} ) + {C}_{c} ( {\hat{γ}}_{l} ) )$$
in which expression:
Cᵥ(\hat{γ}ₗ) is a criterion quantifying a reconstruction error between the intensity vector of biological sample x and reconstruction \hat{x}ₗ of intensity vector x by a candidate model \hat{γ}ₗ; and
C_{c}(\hat{γ}ₗ) is a criterion quantifying the complexity of a candidate model \hat{γ}ₗ;
and determining the relative abundance in biological sample Cⱼ of a reference taxon yⱼ according to relation:
C=J(ŷₛₑₗ)
in which expression J is a matrix function of Rₗ^{p}×Pₗ^{K} in Rₗ^{K} and C=(C₁ . . . Cⱼ . . . C_{K})^{T} is a vector of Rₗ^{K} with ∀jε[[1,K]], Cⱼ is the relative abundance of reference taxon yⱼ.

4. The method of claim 1, wherein ∀(i,j)ε[[1,K]]², aᵢⱼ is a coefficient of similarity between reference vectors Pᵢ and Pⱼ of reference taxa yᵢ and yⱼ.

5. The method of claim 4, wherein the coefficient of similarity aᵢⱼ between reference vectors Pᵢ and Pⱼ is equal to the Jaccard coefficient between binarized versions of vectors Pᵢ and Pⱼ.

6. The method of claim 1, wherein ŷ₀=0, and wherein the construction of set {\hat{γ}ₗ} of candidate models \hat{γ}ₗ=(ŷ,0)ₗ comprises solving a set of optimization problems for values of a parameter λ of Rₗ, each problem being defined according to relation:
$$\hat{γ} ( λ ) = {argmin}_{γ ∈ {R}_{+}^{K}} ( {‖ x - {\sum }_{j = 1}^{K} {γ}_{j} {p}_{j}^{( a )} ‖}^{2} + λ {\vert γ \vert}_{1} )$$
in which expression |y|₁ is norm L1 of vector y.

7. The method of claim 1, wherein ŷ₀=0, and wherein the construction of set {\hat{γ}ₗ} of candidate models \hat{γ}ₗ=(ŷ,0)ₗ comprises solving a set of optimization problems for values of parameters λ and β of Rₗ, each problem being defined according to relation:
$$\hat{γ} ( λ , β ) = {argmin}_{γ ∈ {R}_{+}^{K}} ( {‖ x - {\sum }_{j = 1}^{K} {γ}_{j} {P}_{j}^{( a )} ‖}^{2} + λ {\vert {w}_{1} ⊙ γ \vert}_{1} + β {\vert {w}_{2} ⊙ γ \vert}_{2} )$$
in which expression:

||₁ is norm L1;

||₂ is norm L2;
a⊙b is the term-by-term product of vectors a and b; and
w₁ and w₂ are vectors of predetermined weight of Rₗ^{K}.

8. The method of claim 6, wherein for each vector ŷ solution of an optimization problem, a new candidate model \hat{γ}ₗ=(ŷ^{lm},ŷ₀^{lm})ₗ is calculated, and replaces model \hat{γ}ₗ=(ŷ,0)ₗ corresponding to vector ŷ, the components of vector ŷ^{lm} of the new model \hat{γ}ₗ=(ŷ^{lm},ŷ₀^{lm})ₗ, corresponding to the zero components of vector ŷ, being forced to zero, and the new model \hat{γ}ₗ=(ŷ^{lm},ŷ₀^{lm})ₗ being calculated by solving the optimization problem according to relations:
$$( {\hat{γ}}^{lm} , {\hat{γ}}_{0}^{lm} ) = {argmax}_{{{γ}_{0}^{lm} ∈ {R}_{+}}_{{γ}^{lm} ∈ {R}_{+}^{K}}} ( - \frac{p}{2} ln ( 2 {πσ ( {x}_{l} )}^{2} ) - \frac{1}{2 {σ ( {x}_{l} )}^{2}} {\sum }_{b = 1}^{p} {( {x}_{b} - {x}_{lb} )}^{2} )$$
$${σ ( {x}_{l} )}^{2} = \frac{1}{p} {\sum }_{b = 1}^{p} {( {x}_{b} - {x}_{lb} )}^{2} \\ {x}_{l} = {γ}_{0}^{lm} {I}_{p} + {\sum }_{j \text{:} {\hat{γ}}_{j} \neq 0} {γ}_{j}^{lm} {p}_{j}^{( a )}$$
in which expression:
x_{b} is the b^{th} component of the intensity vector of biological sample x; and
x_{1b}, is the b^{th} component of reconstruction vector xₗ=y₀^{lm}Iₚ+Σ_{j(ŷ}_{ⱼ}_{>0}yⱼ^{lm}Pⱼ^{(a)}.

9. The method of claim 1, wherein the criterion Cᵥ(\hat{γ}ₗ) quantifying the reconstruction error is a likelihood criterion.

10. The method of claim 9, wherein:
$${C}_{v} ( {\hat{γ}}_{l} ) = - \frac{p}{2} ln ( 2 π {\hat{σ}}^{2} ) - \frac{1}{2 {\hat{σ}}^{2}} {\sum }_{b = 1}^{p} {( {x}_{b} - {\hat{x}}_{lb} )}^{2}$$
in which expression:
$${\hat{σ}}^{2} = \frac{1}{p} {{Σ}_{b = 1}^{p} ( {x}_{b} - {\hat{x}}_{lb} )}^{2} ;$$
x_{b} is the b^{th} component of the peak vector of biological sample x; and
\hat{x}_{1b} is the b^{th} component of reconstruction vector \hat{x}ₗ of candidate model \hat{γ}ₗ.

11. The method of claim 1, wherein criterion C₀(\hat{γ}ₗ) quantifying the complexity of model \hat{γ}ₗ quantifies said complexity in terms of number of strictly positive components ŷⱼ of vector ŷ.

12. The method of claim 11, wherein:
$$If {\hat{γ}}_{0} = 0 then {C}_{c} ( {\hat{γ}}_{l} ) = ( 1 + {\sum }_{j = 1}^{K} 1 ( {\hat{γ}}_{j} > 0 ) ) ln p$$
$$If {\hat{γ}}_{0} \neq 0 then {C}_{c} ( {\hat{γ}}_{l} ) = ( 2 + {\sum }_{j = 1}^{K} 1 ( {\hat{γ}}_{j} > 0 ) ) ln p$$
in which expression function 1(.) is equal to 1 if its argument is true and zero otherwise.

13. The method of claim 1, wherein the taxa belong to a same taxonomic level, particularly the species, genus, or sub-species level.

14. The method of claim 1, wherein the taxa belong to at least two different taxonomic level, particularly species, genera, and/or sub-species.

15. The method of claim 1, wherein taxa belong to a first taxonomic level, and wherein a model of vector x is calculated for a second taxonomic level higher than the first taxonomic level by adding the components of vector ŷ corresponding to the taxa depending on said higher taxonomic level.

16. The method of claim 15, wherein the model of vector x is calculated for the higher taxonomic level if a degree of similarity within the first level is greater than a predetermined threshold.

17. The method of claim 1, wherein if a degree of similarity between a set of taxa defines within a first taxonomic level is greater than a predetermined threshold, then, for the forming of the predetermined set {ŷⱼ} of reference taxa, said taxa are gathered and replaced with a reference taxon defined at a second taxonomic level, higher than the first taxonomic level.

18. The method of claim 1, wherein the measurement technique generates a spectrum and wherein reference intensity vectors Pⱼ are lists of peaks comprised in the spectrums of reference taxa yⱼ.

19. The method of claim 18, wherein the measurement technique comprises a mass spectrometry.

20. The method of claim 3, wherein:
$${C}_{j} = \frac{{\hat{γ}}_{j , set}}{{Σ}_{i = 1}^{K} {\hat{γ}}_{i , set}}$$
in which expression ∀jε[[1,K]], ŷ_{j,sel} is the j^{th} component of vector ŷ of selected model ŷₛₑₗ.

21. A device for analyzing a biological sample comprising:
a spectrometer or a spectroscope capable of generating spectrums of the biological sample;
a calculation unit capable of implementing the method of claim 1.
